(19) United States
(12) Patent Application Publication
(10) Pub. No.: US 2024/0208468 A1
(43) Pub. Date: Jun. 27, 2024

(54) SYSTEM AND METHOD FOR CONTROLLING A BRAKE CONTROL SYSTEM

(71) Applicant: Bendix Commercial Vehicle Systems LLC, Avon, OH (US)

(72) Inventors: Juan M. Gomez, Mountain View, CA (US); Cody D. Kuepfer, Westlake, OH (US)

(21) Appl. No.: 18/069,560

(22) Filed: Dec. 21, 2022

(51) Int. Cl. B60T 7/12; B60W 10/18; B60W 40/08; B60W 50/10; B60W 50/14

(52) U.S. Cl. CPC B60T 7/12; B60W 10/182; B60W 40/08; B60W 50/10; B60W 50/14; B60T 2201/024; B60T 2201/10; B60W 2040/0881; B60W 2050/143; B60W 2050/146; B60W 2540/10; B60W 2710/188

(57) ABSTRACT

A vehicle braking control system includes a vehicle brake controller configured to receive a driver assistance vehicle stopped signal from a driver assistance system feature on the vehicle. The driver assistance vehicle stopped signal indicates the vehicle has been stopped by the driver assistance system feature. The vehicle brake controller is also configured to receive a driver override signal, if a driver of the vehicle engages an interactive system of the vehicle. The vehicle brake controller is also configured to, if the driver override signal is not received within a predetermined time after receiving the driver assistance vehicle stopped signal, transmit a park brake engagement signal to engage a parking brake on the vehicle.

### BACKGROUND

The present invention relates to a brake hold assist (BHA) system. It finds particular application in conjunction with a BHA system during automated braking and will be described with particular reference thereto. It will be appreciated, however, that the invention is also amenable to other applications.

Driver exhaustion is a major challenge in commercial vehicle transportation. Drivers endure long and stressful trips in urban and highway conditions and easily become fatigued in these environments. When fatigued, drivers become less apt to maintain constant pressure on the service brake pedal to keep the vehicle at a stop in red lights, stopped traffic, stop signs, and even after braking scenarios actuated by autonomous headway control devices (e.g., emergency braking). In addition, a driver may not be psychologically or physically in a position to hold the service brake pedal after an emergency situation.

The present invention provides a new and improved apparatus and method which addresses the above-referenced problems.

### SUMMARY

In one aspect of the present invention, a vehicle braking control system includes a vehicle brake controller configured to receive a driver assistance vehicle stopped signal from a driver assistance system feature on the vehicle. The driver assistance vehicle stopped signal indicates the vehicle has been stopped by the driver assistance system feature. The vehicle brake controller is also configured to receive a driver override signal, if a driver of the vehicle engages an interactive system of the vehicle. The vehicle brake controller is also configured to, if the driver override signal is not received within a predetermined time after receiving the driver assistance vehicle stopped signal, transmit a park brake engagement signal to engage a parking brake on the vehicle.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a vehicle with a vehicle braking control system in accordance with one embodiment of an apparatus illustrating principles of the present invention; and

FIG. 2 is an exemplary methodology of controlling the vehicle braking control system of FIG. 1 in accordance with one embodiment illustrating principles of the present invention.

### DETAILED DESCRIPTION OF ILLUSTRATED EMBODIMENT

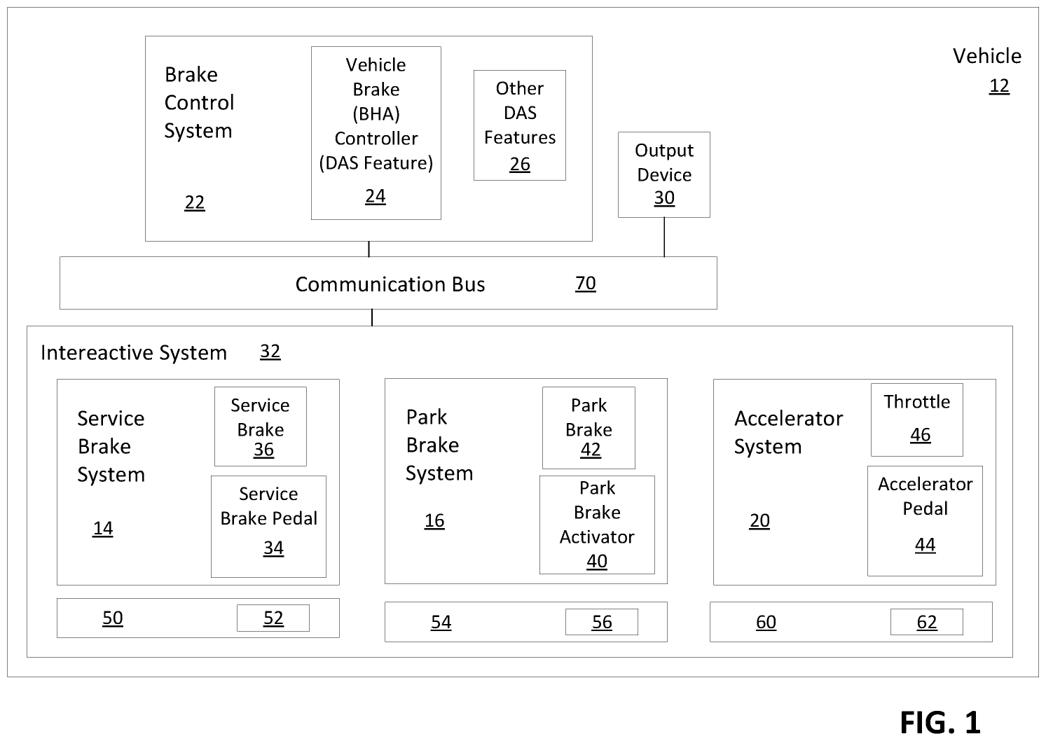

With reference to FIG. 1, a simplified component diagram of an exemplary vehicle 12 including a service brake system 14, a park brake system 16, an accelerator system 20 and various other vehicle systems and components is illustrated in accordance with one embodiment of the present invention. For example, the vehicle 12 includes a vehicle braking control system 22 that includes a vehicle brake controller 24 (e.g., an electronic control unit (ECU)). In one embodiment, the vehicle braking control system 22 is a brake hold assist (BHA) system, which is an example of a driver assistance system (DAS) feature. The vehicle 12 also includes other DAS features 26 such as, for example, an automated braking system (e.g., an emergency braking system, a collision mitigation braking system, a highway departure braking system) and an adaptive cruise control system. For purposes of illustration, the other DAS features are illustrated as a single component 26 as part of the vehicle braking control system 22 in FIG. 1.

The vehicle 12 also includes an output device 30 that provides a signal (e.g., a warning) to a driver of the vehicle 12. In one example, the output device 30 is a light in a cab of the vehicle 12 that illuminates/turns-off to communicate a status signal to the driver. Other examples of the output device 30 include different visual and/or audio devices to communicate status signals to the driver.

An interactive system 32 (e.g., a human-machine interface (HMI) device) electrically communicates with the vehicle brake controller 24 and the output device 30. For purposes of illustration, the service brake system 14, the park brake system 16 and/or the accelerator system 20 are shown as part of the interactive system 32 in FIG. 1. Although the output device 30 is illustrated as a separate component from the HMI 32 in FIG. 1, other embodiments are contemplated in which the output device 30 is included as part of the HMI 32.

The service brake system 14 includes a service brake pedal 34, which the driver interacts with (e.g., depresses/releases) to apply/release (engage/disengage) service brakes 36 of the service brake system 14. When the driver depresses the service brake pedal 34, the service brake system 14 transmits a service brake signal (e.g., a driver override signal) to the vehicle brake controller 24.

The park brake system 16 includes a park brake activator 40, which the driver interacts with to apply/release (engage/disengage) park brakes 42 of the park brake system 16. When the driver applies the park brake activator 40, the park brake system 16 transmits a park brake signal (e.g., a driver override signal) to the vehicle brake controller 24.

The accelerator system 20 includes an accelerator pedal 44, which the driver interacts with to apply/release (engage/disengage) a throttle 46 to accelerate the vehicle 12. When the driver applies the accelerator pedal 44, the accelerator system 20 transmits an accelerator signal (e.g., a driver override signal) to the vehicle brake controller 24.

In one embodiment, the output device 30 includes its own HMI that the driver can interact with to, for example, silence the warning and/or transmit a signal to the vehicle brake controller 24.

The vehicle 12 also includes a seat belt system 50, which includes a driver seat belt 52 used to secure a driver in a driver seat of the vehicle 12, a driver seat occupancy system 54 used to sense when the driver seat 56 is occupied, and a door system 60 used to sense when a driver door 62 of the vehicle 12 is opened. It is contemplated that the seat belt system 50, the driver seat occupancy system 54 and the door system 60 are also part of the interactive system 32.

In one embodiment, the seat belt system 50 transmits a signal to the vehicle brake controller 24 when the driver of the vehicle engages/disengages the driver seat belt 52. For example, the seat belt system 50 transmits a driver engagement signal to the vehicle brake controller 24 when the driver of the vehicle engages the driver seat belt 52. Conversely, the seat belt system 50 transmits a driver disengagement signal to the vehicle brake controller 24 when the driver of the vehicle disengages the driver seat belt. It is assumed that the seat belt system 50 sensing the driver seat belt 52 becomes engaged (e.g., buckled) indicates the driver is engaging with the vehicle 12 (e.g., has entered the vehicle 12 and is ready to drive), and that the seat belt system 50 sensing the driver seat belt 52 becomes disengaged (e.g., unbuckled) indicates the driver is disengaging from the vehicle 12 (e.g., is not ready to drive the vehicle 12 and is planning to exit the vehicle 12).

In one embodiment, the driver seat occupancy system 54 transmits a signal to the vehicle brake controller 24 when the driver of the vehicle engages/disengages the driver seat 56. For example, the driver seat occupancy system 54 transmits a driver engagement signal to the vehicle brake controller 24 when the driver of the vehicle engages with the driver seat 56. Conversely, the driver seat occupancy system 54 transmits a driver disengagement signal to the vehicle brake controller 24 when the driver of the vehicle disengages from the driver seat 56. It is assumed that the driver seat occupancy system 54 sensing the driver seat 56 becoming engaged indicates the driver is engaging with the vehicle 12 (e.g., the driver has entered and is sitting in the driver seat), and that the driver seat occupancy system 54 sensing the driver seat becoming disengaged indicates the driver is disengaging from the vehicle 12 (e.g., the driver has exited, is not sitting in the driver seat and is planning to exit the vehicle 12).

In one embodiment, the door system 60 transmits a signal to the vehicle brake controller 24 when the driver of the vehicle closes/opens the driver door. For example, the door system 60 transmits a driver engagement signal to the vehicle brake controller 24 when the driver of the vehicle closes the driver door. Conversely, the door system 60 transmits a driver disengagement signal to the vehicle brake controller 24 when the driver of the vehicle opens the driver door. It is assumed that the door system 60 sensing the driver door is closed indicates the driver is engaging with the vehicle 12 (e.g., the driver has entered the vehicle 12), and that the door system 60 sensing the driver door opens indicates the driver is disengaging from the vehicle 12 (e.g., the driver is exiting the vehicle 12).

Since the driver engagement signal and driver disengagement signal may indicate a driver's alertness and/or attentiveness, the driver engagement signal and driver disengagement signal may also be referred to as driver alertness signals and driver attentiveness signals.

In one embodiment, the vehicle 12 includes a vehicle communication bus 70 that communicates electronic signals between various components on the vehicle 12. For example, each of the service brake system 14, the park brake system 16, the accelerator system 20, the seat belt system 50, the driver seat occupancy system 54 and the door system 60, which are part of the interactive system 32, all electrically communicate with the communication bus 70. Similarly, the vehicle brake controller 24 and other DAS features 26, which are part of the braking control system 22, each electrically communicates with the communication bus 70. The output device 30 also electrically communicates with the communication bus 70. Each of the components electrically connected to the communication bus 70 is capable of electrically communicating with the other components via the bus 70. Although the illustrated embodiment shows each of the components electrically communicating with each other via the communication bus 70, other embodiments are also contemplated in which each of the components electrically communicating with each other via direct wired, or even wireless, connections.

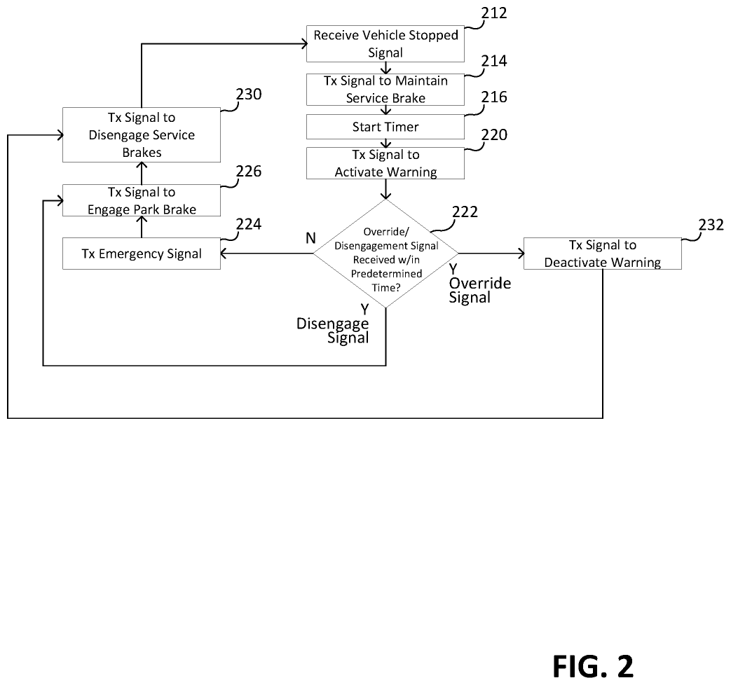

With reference to FIG. 2, an exemplary methodology of the system shown in FIG. 1 for controlling the braking control system 22 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1 and 2, the vehicle brake controller 24 (e.g., the BHA controller) receives, in a step 212, a driver assistance vehicle stopped signal from one of the other DAS features (e.g., from one of the automated braking systems, such as the emergency braking system, the collision mitigation braking system, the highway departure braking system, or from the adaptive cruise control system). The driver assistance vehicle stopped signal received in the step 212 indicates the vehicle 12 has been stopped by at least one of the DAS features automatically applying the service brakes 36. Upon receiving the driver assistance vehicle stopped signal in the step 212, the BHA controller 24, in a step 214, transmits a signal to the service brake system 14 to maintain the service brakes 36 in the applied position for keeping the vehicle 12 stopped. Also, upon receiving the driver assistance vehicle stopped signal in the step 212, the BHA controller 24, in a step 216, starts a timer. In addition, upon receiving the driver assistance vehicle stopped signal in the step 212, the BHA controller 24 optionally, in a step 220, transmits a signal to the output device 30 to activate a warning to the driver that the vehicle 12 has been stopped by the driver assistance system feature.

In a step 222, the BHA controller 24, determines if either a driver override signal or a driver disengagement signal is received within a predetermined time (e.g., about 60 seconds) after the driver assistance vehicle stopped signal was received in the step 212. For example, the driver override signal or the driver disengagement signal may be received from any of the systems included in the interactive system 32. If no signal is received in the step 222 within the predetermined time, it is assumed that the driver is in distress and/or incapacitated. For example, the driver may be in distress and/or incapacitated if the vehicle was in an accident (e.g., collided with another object) and the driver assistance vehicle stopped signal was received in the step 212. In this case, control passes to a step 224 to wirelessly transmit an emergency signal from the vehicle to a remote location (e.g., a fleet manager or any individual previously determined that should receive such an emergency signal). Then, in a step 226, the BHA controller 24 transmits a park brake engagement signal to the park brake system 16 for causing the park brakes 42 to be applied. Then, in a step 230, the BHA controller 24 transmits a service brake disengagement signal to the service brake system 14 to disengage the service brakes 36 as an anti-compounding measure (e.g., to avoid both the service brakes 36 and the park brake 42 being simultaneously applied). Control then returns to the step 212.

If the driver override signal is received within the predetermined time in the step 222, it is assumed that the driver is not in distress or injured (e.g., since the driver has actively engaged with the vehicle 12 within the predetermined time). For example, the driver may have depressed the service brake pedal 34, interacted with the park brake activator 40, depressed the accelerator pedal 44 and/or interacted with the HMI (e.g., pressed a button) on the output device 30. In one embodiment, releasing the service brake pedal 34 and/or the accelerator pedal 44 is not considered an interaction the driver has with the vehicle 12 that indicates the driver is not in distress or injured and, therefore, a driver override signal is not received in the step 222. If the driver override signal is received within the predetermined time in the step 222, control passes to a step 232 for transmitting a signal from the BHA controller 24 to the output device 30 to deactivate the warning. As discussed above, since the driver override signal has been received within the predetermined time, it is assumed the driver is not in distress and/or incapacitated. Therefore, control passes from the step 232 to the step 230 for transmitting a signal from the BHA controller 24 to the service brake system 14 for disengaging the service brakes 36. Then, control returns to the step 212.

If the driver disengagement signal is received within the predetermined time in the step 222, it is assumed the driver is disengaging from the vehicle 12. For example, the driver may have unbuckled the driver seat belt 52, disengaged from the driver seat 56 and/or opened the driver door 62. In this case, control passes from the step 222 to the step 226 for transmitting a park brake engagement signal to the park brake system 16 for causing the park brakes 42 to be applied. Then, in the step 230, the BHA controller 24 transmits a service brake disengagement signal to the service brake system 14 to disengage the service brakes 36 to avoid compounding the service brakes 36 and the park brakes 42. Control then returns to the step 212.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A vehicle braking control system, comprising:
a vehicle brake controller configured to:
receive a driver assistance vehicle stopped signal, from a driver assistance system feature on the vehicle, indicating the vehicle has been stopped by the driver assistance system feature;
receive a driver override signal if a driver of the vehicle engages an interactive system of the vehicle; and
if the driver override signal is not received within a predetermined time after receiving the driver assistance vehicle stopped signal, transmit a park brake engagement signal to engage a parking brake on the vehicle.

2. The vehicle braking control system as set forth in claim 1, wherein the vehicle brake controller is further configured to:
upon receiving the driver assistance vehicle stopped signal, transmit a signal to engage a service brake of the vehicle to maintain the vehicle stopped.

3. The vehicle braking control system as set forth in claim 2, wherein the vehicle brake controller is further configured to:
upon transmitting the park brake engagement signal, transmit a signal to disengage the service brake.

4. The vehicle braking control system as set forth in claim 2, wherein the vehicle brake controller is further configured to:
if the driver override signal is received within a predetermined time after receiving the driver assistance vehicle stopped signal, transmit a signal to disengage the service brake of the vehicle.

5. The vehicle braking control system as set forth in claim 1, wherein the vehicle brake controller is further configured to:
receive the driver assistance vehicle stopped signal from an automated braking system on the vehicle.

6. The vehicle braking control system as set forth in claim 5, wherein:
the automated braking system is an emergency braking system.

7. The vehicle braking control system as set forth in claim 5, wherein:
the automated braking system includes at least one of a collision mitigation system, a highway departure braking system and an adaptive cruise control system.

8. The vehicle braking control system as set forth in claim 1, wherein the vehicle brake controller is further configured to:
upon receiving the driver assistance vehicle stopped signal, transmit a signal to an output device to activate a warning that the vehicle has been stopped by the driver assistance system feature.

9. The vehicle braking control system as set forth in claim 8, wherein:
the interactive system includes a human-machine interface device that electrically communicates with the vehicle brake controller and controls the warning on the output device.

10. The vehicle braking control system as set forth in claim 9, wherein:
if the driver engages with the human-machine interface device to deactivate the warning on the output device, the human-machine interface device transmits the driver override signal to the vehicle brake controller.

11. The vehicle braking control system as set forth in claim 1, wherein:
the interactive system includes at least one of a service brake system, a park brake system and an accelerator system of the vehicle.

12. The vehicle braking control system as set forth in claim 11, wherein:
if the driver applies a service brake of the service brake system, the service brake system transmits the driver override signal to the vehicle brake controller;
if the driver disengages a park brake of the park brake system, the park brake system transmits the driver override signal to the vehicle brake controller; and
if the driver applies an accelerator of the accelerator system, the accelerator system transmits the driver override signal to the vehicle brake controller.

13. The vehicle braking control system as set forth in claim 1, wherein:
the predetermined time is about 60 seconds.

14. The vehicle braking control system as set forth in claim 1, wherein the vehicle brake controller is further configured to:
receive a driver disengagement signal if the driver takes action to disengage from the vehicle.

15. The vehicle braking control system as set forth in claim 14, wherein the vehicle brake controller is further configured to:
if the driver disengagement signal is received within the predetermined time after receiving the driver assistance vehicle stopped signal, transmit the park brake engagement signal to engage the parking brake on the vehicle.

16. The vehicle braking control system as set forth in claim 14, wherein:
a seat belt system transmits the driver disengagement signal if the seat belt system senses a driver seat belt is disengaged;
a driver seat system transmits the driver disengagement signal if the driver seat system senses the driver exits a driver seat; and
a door system transmits the driver disengagement signal if the door system senses a driver door is opened.

17. The vehicle braking control system as set forth in claim 16, wherein:
at least one of i) the seat belt system sensing the driver seat belt is disengaged, ii) the driver seat system sensing the driver exits the driver seat and iii) the door system sensing the driver door is opened indicates the driver is taking action to disengage from the vehicle.

18. A method for controlling a vehicle braking system, the method comprising:
receiving a driver assistance vehicle stopped signal, indicating the vehicle has been stopped by a driver assistance system feature on the vehicle, into a vehicle brake controller from the driver assistance system feature;
receiving a driver override signal, into the vehicle brake controller, if a driver of the vehicle engages an interactive system of the vehicle; and
if the driver override signal is not received within a predetermined time after receiving the driver assistance vehicle stopped signal, transmitting a park brake engagement signal, from the vehicle brake controller, to engage a parking brake on the vehicle.

19. The method for controlling a vehicle braking system as set forth in claim 18, the method further including:
upon receiving the driver assistance vehicle stopped signal, transmitting a signal, from the vehicle brake controller, to engage a service brake of the vehicle to maintain the vehicle stopped.

20. The method for controlling a vehicle braking system as set forth in claim 19, the method further including:
upon transmitting the park brake engagement signal, transmitting a signal, from the vehicle brake controller, to disengage the service brake.

21. The method for controlling a vehicle braking system as set forth in claim 18, the method further including:
receiving the driver assistance vehicle stopped signal from an automated braking system on the vehicle.

22. The method for controlling a vehicle braking system as set forth in claim 18, the method further including:
upon receiving the driver assistance vehicle stopped signal, transmitting a signal, from the vehicle brake controller, to an output device to activate a warning that the vehicle has been stopped by the driver assistance system feature.

23. The method for controlling a vehicle braking system as set forth in claim 22, the method further including:
if the driver engages with an interface device to deactivate the warning on the output device, transmitting a driver override signal from the interface device to the vehicle brake controller.

24. The method for controlling a vehicle braking system as set forth in claim 18, wherein the interactive system includes at least one of a service brake system, a park brake system and an accelerator system of the vehicle, the method further including:
if the driver applies a service brake of the service brake system, transmitting the driver override signal from the service brake system to the vehicle brake controller;
if the driver disengages a park brake of the park brake system, transmitting the driver override signal from the park brake system to the vehicle brake controller; and
if the driver applies an accelerator of the accelerator system, transmitting the driver override signal from the accelerator system to the vehicle brake controller.

25. The method for controlling a vehicle braking system as set forth in claim 18, the method further including:
receiving a driver disengagement signal, into the vehicle brake controller, if the driver takes action to disengage from the vehicle; and
if the driver disengagement signal is received within the predetermined time after receiving the driver assistance vehicle stopped signal, transmitting the park brake engagement signal to engage a parking brake on the vehicle.

26. The method for controlling a vehicle braking system as set forth in claim 25, the method further including:
if a seat belt system senses a driver seat belt is disengaged, transmitting the driver disengagement signal from the seat belt system;
if a driver seat system senses the driver exits a driver seat, transmitting the driver disengagement signal from the driver seat system; and
if a door system senses a driver door is opened, transmitting the driver disengagement signal from the door system.
